(19) United States
(12) Patent Application Publication
(10) Pub. No.: US 2012/0253997 A1
(43) Pub. Date: Oct. 4, 2012

(54) Method for multi-dimensional accounting of business transactions and system therefor

(76) Inventor: Alexey Yevgenyevich KOVALEV, Novosibirsk (RU)

(21) Appl. No.: 13/365,530

(22) Filed: Feb. 3, 2012

Related U.S. Application Data
(60) Provisional application No. 61/516,139, filed on Mar. 30, 2011.

(51) Int. Cl. G06Q 40/00

(52) U.S. Cl. 705/30

(57) ABSTRACT

The present disclosure introduces a computer implemented method and system for business transaction properties registration represented by an event data sheet of the multidimensional data model. The usage of multidimensional data processing tools, such as OLAP, allows one to produce reports corresponding to the requirements of traditional accounting reports quickly and with minimum costs. Examples of such reports are as follows: balance sheet, profit and loss statement, and many others. It allows one to perform all the accounting functions, simplify the execution thereof, enhance them, and significantly increase the capabilities of accounting data analysis.

### CROSS-REFERENCE TO RELATED APPLICATIONS

The present patent application claims the benefit a U.S. provisional patent application Ser. No. 61/516,139 filed on Mar. 30, 2011, the disclosure of which is incorporated herein in its entirety by reference.

### BACKGROUND OF THE INVENTION

I. Field of the Invention

The present invention relates to general principles of accounting and computer software for implementation thereof.

II. Description of Related Art

There are known on the market numerous software applications for maintaining the accounting records. Essentially, all these applications are built upon a classical accounting concept with the use of accounts and double entry to the credit of one account and to the debit of another account. The accounts are used as a main tool for structuring the economic data.

There is known US20030033225 teaching “a software apparatus for journaling accounting transactions into a multi-dimensional data structure and for extracting those transactions from the multi-dimensional data structure and generating ledger accounts, balance statements and the other components of the Generally Accepted Accounting Principles (GAAP). A user either enters an accounting journal entry directly into the Multi-dimensional Accounting Engine or indirectly from another program or external file. The Multi-dimensional Accounting Engine converts the entry from its flat (without dimension) form into a multi-dimensional data structure such as the data structures prevalent in data warehousing. The user can then use the Multi-dimensional Accounting Engine to, on demand, generate ledger accounts, balance sheets and financial statements. All of the recommendations of the GAAP can be generated dynamically using this invention.” As in the traditional accounting, the publication contemplates credit and debit. Though it recognizes uselessness of a paper bookkeeping journal, it does not specify how an electronic journal should be implemented, and what entry structure it should employ, and what method should be utilized for operating the system.

There is also known an article ‘Design of a Multidimensional Accounting System’ written by William D. Haseman and Andrew B. Whinston (The Accounting Review Vol. 51, No. 1 (January, 1976), pp. 65-79). While the term of ‘multidimensional accounting’ has been known, the instant inventor, based on a search conducted by him, could not find in the related art any accounting procedure implemented in the form of a solid multidimensional model in an integrated event data sheet with a confirmation of double-records and saving the balance.

There is known a U.S. Pat. No. 5,884,284 “Telecommunication user account management system and method” issued Mar. 16, 1999, according to which: “The invention creates, maintains, processes and analyzes data regarding individual users for telecommunication services. Billing for individual users is generated. The user data is analyzed and reports for all or part of the user data are prepared and generated. Ancillary functions are enabled, including word processing, editing, e-mail, and other functions. The invention is applicable to subscriber telecommunication services, and pay-for-use services, and the user may be a subscriber or a non-subscriber. The invention is applicable to multi-channel telecommunication services, or single channel multi-service telecommunications, or single channel single service telecommunications.” U.S. Pat. No. 5,884,284 teaches several ‘categories’ implemented in the form of codes. However, the implementation of the system is significantly complicated and therefore the costs for its development and maintaining are estimated to be high.

There is known a U.S. Pat. No. 6,275,813 “Method and device for posting financial transactions in computerized accounting systems” issued 14 Aug. 2001. It allows for control of the correctness of entries of accounting data. It's premised on the notion that any financial operation can be determined by a unique record for transferring from the book of original entry records into the ledger. The record includes a reference number, date, currency, monetary amount, and category directed code, which category directed code is composed of an assigned location code and an initial category code. The record is arranged in one line, it does not utilize negative values. Thusly, the operation journal is characterized with a mono-dimensional structure. As a result, the accounting data require additional program processing, which is expensive and inconvenient.

There is known a U.S. Pat. No. 6,330,545 “Activity information accounting method and system” issued 11 Dec. 2001. It teaches: “The activity information accounting system stores an account title table corresponding to activity information, and performs accounting procedures on the basis of an input activity information and an account title corresponding to the input activity information. The accounting system displays activity types including purchase and acquisition activity, sales and revenue activity, expenditure activity, investment and finance activity, and production activity. If user selects one of the displayed activity types, the accounting system displays a screen for the user to input activity information for the selected activity type. The accounting system determines if the input activity information is internal activity or external activity, performs accounting procedures on the basis of determined result and the account title table.” Thus, U.S. Pat. No. 6,330,545 deals with the traditional hierarchical menu arrangement of activity types, and does not serve the purposes of present invention outlined below.

### SUMMARY OF THE INVENTION

The bookkeeping accounts are typically used in a standard accounting practice as tools for primary classification of business transactions. The bookkeeping accounts combine categories and individual properties of these categories. In general, the selection of separate properties reflects the hierarchical nature of the accounts. The number of accounts used in practice is limited, and they cannot effectively register all the parameters of a business transaction. Usually, a sub-account system, analytics on accounts, or even concurrent management of several accounting systems are used for registering a required volume of information about business transactions. The accounting information structure with the use of bookkeeping accounts on its first level (accounting information) of subdivision has the form of a hierarchical system. The ordering of characteristics, inevitable in a hierarchical system, reflects only one point of view and cannot satisfy interests of all users of accounting data. Besides, the research of analytical information, common for several accounts, is difficult and requires a development of special software. The accounting in aggregate business structures and in product distribution chains is complicated as well.

The multidimensional accounting method (herein called ‘MDA’) of business transactions, proposed by the instant invention, represents a novel approach in the accounting art. The basis of MDA is an economic event data sheet arranged in accordance with the classical multidimensional approach of data organization. The MDA contemplates a set of transaction attributes in the form of categories and a registration procedure that allow for forming a multidimensional data construct and carrying out accounting operations directly therefrom, applying known multidimensional data processing tools such as OLAP (On-Line Analytical Processing).

According to preferred embodiments of the inventive method for MDA of business transactions, essential properties of the business transactions are recorded in a structure of basic categories, (the most general independent primitives), herein further called: “MIT” (that stands for “Moment in Time”, when the transaction occurred), “Transaction Object”, and “Transaction Subject”. These categories act as main attributes of the business transactions. The resultant structure corresponds to classical data sheet structures of a multidimensional information model. The multidimensional model has a more universal structure than a hierarchical model and, if necessary, allows one to create hierarchies that enable solving problems of various information users. Thus, MDA allows one to organize accounting in aggregate business structures.

In the MDA data model, analysis is carried out directly on the basis of category properties, without preliminary inclusion of analytical characteristics into accounts, as it is done in the traditional accounting. The double entry in MDA is implemented as a change registration tool in the recorded properties of the Transaction Subject and Transaction Object categories. The balance is based on a special attribute of a dimension table of Transaction Subject. Additionally, the MDA data model has other important attributes: “UOM” (stands for “Unit of Measure”) that contains transaction units of measurement that could be monetary, natural, or of any other kind; and “Value” that within one transaction may take on a negative value or a positive value with equal modulus.

The aforementioned features of MDA make the invention novel and unobvious for one skilled in the related art. According to this invention, the accounting data is organized in correspondence with the multidimensional conceptual data model in the integrated event data sheet. The user extracts data by creating reports with the help of standard multidimensional data processing tools such as OLAP.

A main embodiment of the present invention can be summarized as follows: at least one computer readable medium being a component of a programmable computer, said computer implements a data structure arranged on said readable medium, said data structure comprising: —an integrated economic event data sheet (EEDS) for registering changes of data occurred as a result of a business transaction, said business transaction has a subject, object, units of measure (UOM), and a value; said EEDS is represented by a table including the following economic event attributes: —MIT for recording a date and/or time of the business transaction, the MIT attribute is characterized with a MIT value; —Transaction Object for recording said object of the business transaction, the Transaction Object attribute is characterized with a Transaction Object value; —Transaction Subject for recording said subject of the business transaction, the Transaction Subject attribute is characterized with a Transaction Subject value; —UOM of the business transaction, the UOM attribute is characterized with a UOM value; and—Value for recording said value of the business transaction, wherein the Value attribute assumes either a negative value or a positive value with equal modulus; and—a number of dimensional tables each associated with one of said economic event attributes; and wherein said business transaction is recorded in two states within said EEDS for each said economic event attribute; the two states are represented by a From state and a To state; and wherein: said From state precedes the business transaction and completes as a result of the business transaction, while having a transaction numeric value always being negative; said To state results from the business transaction while having a transaction numeric value always being positive, and a total of the numeric values of said From state and said To state is equal to zero.

An inventive method of the present invention can be summarized as follows: a method for producing an accounting balance sheet of a business entity; said accounting balance sheet is characterized by a balance equation, said business entity defines agents, owners, and financial results; said method comprising the steps of: —providing a computer readable medium being a component of a programmable computer; said computer implements calculations with said agents, said owners, and said financial results; said computer implements a data structure arranged on said readable medium, said data structure includes an integrated economic event data sheet (EEDS) for registering changes of data occurred as a result of a business transaction, said business transaction has an object, units of measure, and a value; said EEDS is represented by a table including economic event attributes of: —MIT for recording a date and/or time of the business transaction, the MIT attribute is characterized with a MIT value; —Transaction Object for recording said object of the business transaction, the Transaction Object attribute is characterized with a Transaction Object value; —UOM for recording said units of measure of the business transaction, the UOM attribute is characterized with a UOM value; and—Value for recording said value of the business transaction, wherein the Value attribute assumes either a negative value or a positive value with equal modulus; —Transaction Subject for recording said subject of the business transaction, the Transaction Subject attribute is characterized with a Transaction Subject value; wherein said Transaction Subject attribute is represented by a Transaction Subject dimension table including an Accounting Area attribute assuming one of two possible values; —assigning one of the two possible values to a single subject or multiple subjects of said transaction, and—establishing a subdivision of the Accounting Area attribute, wherein said subdivision forms two parts of said balance equation.

### BRIEF DESCRIPTION OF THE DRAWINGS

FIG. 1. shows a basic flowchart of a “star” type data organization in MDA, according to an embodiment of the present invention. Reference numeral 10 denotes a multidimensional model data table, herein called an Economic Event Data Sheet (also called EEDS). Reference numerals from 30 to 50 in the FIG. 1 denote Dimension Tables of the EEDS: MIT (30) (that stands for “Moment in Time”, when the transaction occurred), Transaction Subject (40), and Transaction Object (50).

FIG. 2. shows a main structure (70) of the EEDS, depicting double entry features in MDA. The columns can be arranged in an arbitrary order.

FIG. 3. shows a flowchart of extension of EEDS (200) by using values of Dimension Tables. In this case, EEDS (200) is extended (190) by an “Accounting Area” value (185) of the Dimension Table (180) of Transaction Subject. “Accounting Area” is an attribute that can assume only two values, which allows forming a company balance.

FIG. 4. shows the result of EEDS extension (210) by including the Accounting Areas (220).

FIG. 5. Shows a header (230) of EEDS, extended by the Dimension Tables in accordance with the regular business practice and in a volume sufficient for forming a balance sheet.

EEDS is extended with:

“Requisites” of a contract: “Contract Number” (240) and “Contract Type” (250). The accounting in view of contracts is predetermined by accountancy requirements. A “Contract Type” attribute allows one to separate the relationships with clients, vendors, financial organizations, and other relationship types.

“Relations” (260). This attribute separates the relations between shareholders and the company from other relations. It allows one to organize accounting of own sources of the company funds.

“Unit of Measure”, or “UOM” (270), “Value” (280), “Price” (290), “Sum” (300). The use of these attributes allows organizing the analytical accounting of transactions.

“From/To” attribute (310) assumes a value “From” for the “From” line and a value “To” for the “To” line. The use of this attribute simplifies the separate view of disposal and acquisition of assets and change of settlements with counterparts.

“Depreciation” Attribute (320). This attribute is used for the depreciation accounting and assumes one of two possible values: “General” or “Depreciation”.

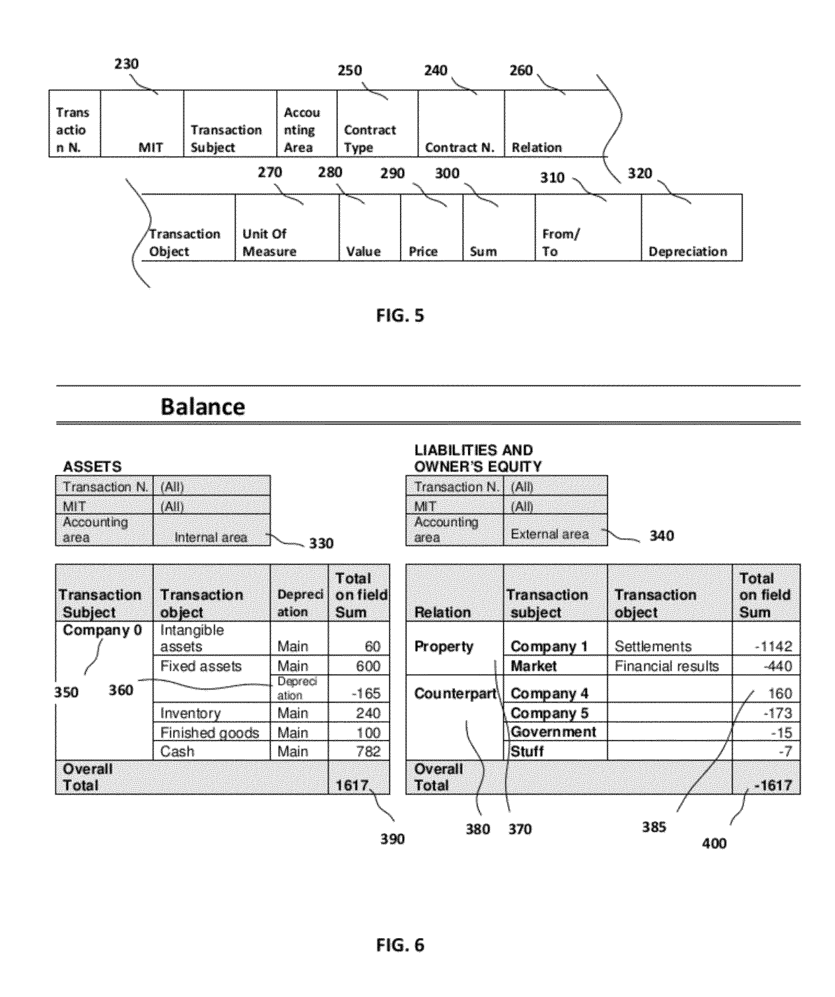

FIG. 6 depicts an example of Balance Sheet, obtained by means of the OLAP tools on the basis of EEDS with extensions (FIG. 5).

### OBJECTS AND ADVANTAGES OF THE INVENTION

The objects and advantages of this invention follow:

1. All essential properties of a business transaction are placed into several main categories in the conceptual multidimensional data model, which significantly simplifies the comprehension of accounting system and data handling. The accounting functions are carried out through standard tools of the multidimensional data processing (OLAP).

2. MDA allows for using all of the advantages of the multidimensional data model, in particular, to add or to carry out accounting in view of additional attributes in dimension tables for the normative accounting, transaction accounting for various assets; providing connections of accounting with planning, business project management, business process management, etc.

3. The assets and the liabilities of the balance sheet can be formed according to all characteristics, registered in the corresponding dimension tables for Transaction Object (Balance Sheet assets) and Transaction Subject (Balance Sheet liabilities).

4. The inventive method employs negative and positive values of measure in one transaction, which allows for simple controlling the accuracy of data entry and simple finding errors. MDA preferably utilizes OLAP, which always results in equal totals in data processing.

5. The use of MDA allows one to organize accounting in aggregated business structures. In order to organize a unified accounting, it is sufficient to simply unite the EEDS tables of the business subjects, i.e. the aggregated group members. The only condition is the uniformity of the dimension tables. MDA allows for creating a balance sheet, profit and loss statement, and other report forms separately for each member of the aggregated structure, for any group of the aggregated structure or for the whole structure. MDA allows for analyzing the business transactions inside one of the groups. For accounting in the aggregated group, all the group members get a value called “Internal Area” of the Accounting Area attribute.

### DETAILED DESCRIPTION OF THE INVENTION

While the invention may be susceptible to embodiment in different forms, there are shown in the drawings, and will be described in detail herein, specific embodiments of the present invention, with the understanding that the present disclosure is to be considered an exemplification of the principles of the invention, and is not intended to limit the invention to that as illustrated and described herein.

As stated above, the basis of MDA is the Economic Event Data Sheet (EEDS). A first basic feature of the present invention is the use of categories called “MIT”, “Transaction Object”, “Transaction Subject”, “UOM”, and “Value” as economic event attributes. Although these attributes are typically present in primary documentation forms of the regular (traditional) accounting, the inventive MDA model is substantially distinct therefrom by providing an essentially different registration method of these attributes.

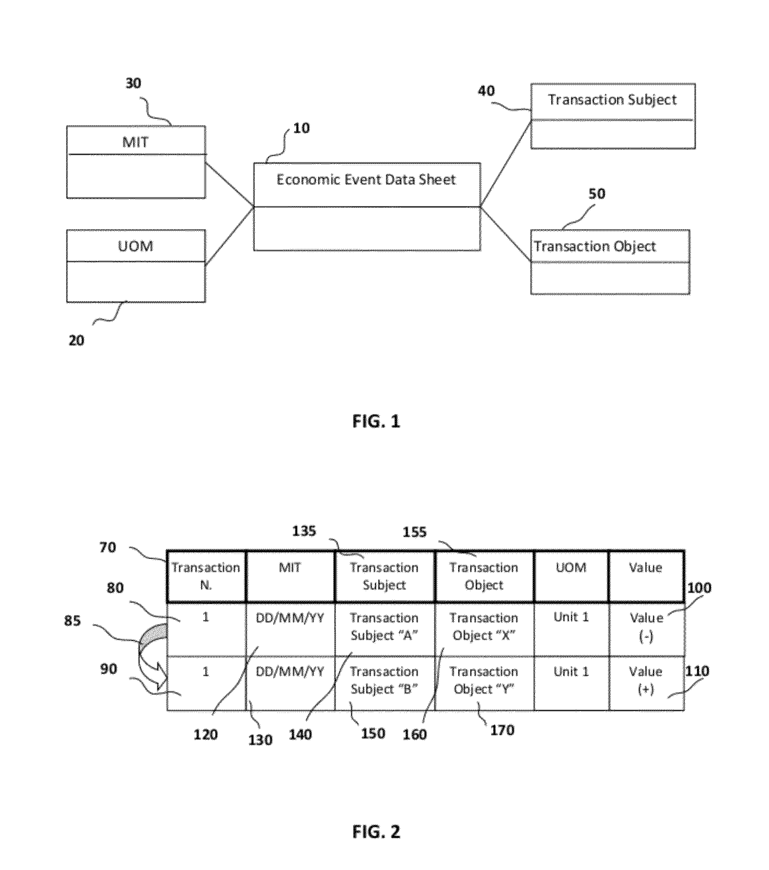

As depicted on FIG. 1, EEDS with the dimension tables collectively form a basic logical structure of data organization in MDA. The following elements are shown in FIG. 1: EEDS (10); and the dimension tables of EEDS: Dimension Table (30) “MIT”, Dimension Table (40) “Transaction Subject”, Dimension Table (50) “Transaction Object”, and Dimension Table (20) “UOM”.

According to a user's requirements, there may be indicated not only the date, but also the posting time. Table (30) can have a hierarchical structure, wherein the dates are grouped in periods: week, decade, month, accounting period, year, and others. Table (40) may contain: transaction details by subject units and subject details (address, registration numbers and so on), relation to Accounting Area and other information, relative to Transaction Subject. Table (50) can contain properties of Transaction Object, such as: an inventory number, physical and other characteristics (for example, start-up date, registration date, maintenance date; membership of the Object in various asset groups: fixed assets, raw materials, unfinished goods, cash assets and others). UOM table (20) can be used for registration of existing transaction units of measurement: natural, monetary, and others.

As noted above, the basic logic structure of data organization in MDA is of the “star” type. Nonetheless, the extension of properties, registered in the dimension tables, often results in formation of hierarchical structures in the dimension tables. In this case, the logical structure of data organization in MDA represents a “snowflake” schema for arrangement of tables in a multidimensional database.

The second major development in MDA is a method of double entry implementation. The double entry, known in the accounting for 500 years, is implemented in a new way in MDA.

The double entry is implemented as a tool for registering changes that occurred as a result of the business transaction. MDA allows one to register all the changes of attribute values occurred as a result of the business transaction and the volume (amount) of these changes.

Another distinct feature of MDA is a specific form of the double entry record: it does not include the debit and credit, but instead uses a positive and a negative numeric value of the transaction amount, which positive and negative values are equal by modulus.

FIG. 2. shows the general structure of EEDS (70) taking into consideration the double entry characteristic of MDA. Each business transaction in EEDS reflects two states of an accounting item. The first state is “From” (80); the second state is “To” (90). The first state “From” precedes the business transaction and completes as a result of the business transaction, while its transaction numeric value is always negative (100). The second state “To” (90) is a result of the business transaction and its transaction numeric value of is always positive (110). An arrow (85) marks the transition from one state to the other as a result of the business transaction. A Transaction Number (Transaction n), MIT (120) and (130) are equal for all the lines, within one registered business transaction.

The values of the “From” and “To” states (positive and negative) are described for the accounting of the economic events. For the registration of planned (scheduled) events the number “Value” will have the opposite sign. The sign can also be opposite for other extensions of the possibilities of MDA, which is beyond the modern understanding of accounting.

In case if this is envisaged by the accounting rules, the description of both the “From” and “To” states can include several lines of Data Sheet for one transaction, analogously to the multiple account correspondence in the traditional accountancy. The total value of measure of “From” “To” lines should be equal to zero regardless of the number of lines, describing the transaction.

The order of “From” and “To” lines does not matter. In practice, it is convenient to follow one chosen order of the registration. The multidimensional data organization technically allows placing lines “From” and “To” of one operation not next to, but mixed up with the lines of other transactions, though this option complicates the understanding and the data verification of EEDS.

In the general structure of the EEDS (70) the changes that occurred as a result of the business transaction are displayed in the attribute value of Transaction Subject (135) or in the attribute value of Transaction Object (155) or in both attributes (135) and (155).

The change of Transaction Subject (135) attribute marks the change of asset ownership. In this case the subject of the transaction “A” (140) does not match the transaction “B” (150).

The change of “Transaction Object” (155) attribute marks the change in asset. In this case the object of transaction “X” (160) will not correspond to the object of transaction “Y” (170).

A movement of assets between units of registration (company divisions) within one company can be registered by the MDA tools. In this case the Data Sheet can be extended by including in EEDS an additional business transaction characteristic “Transaction Subject Unit”. When the unit is changed, the “Transaction Subject Unit” values of the field for lines “From” (80) and “To” (90) will differ.

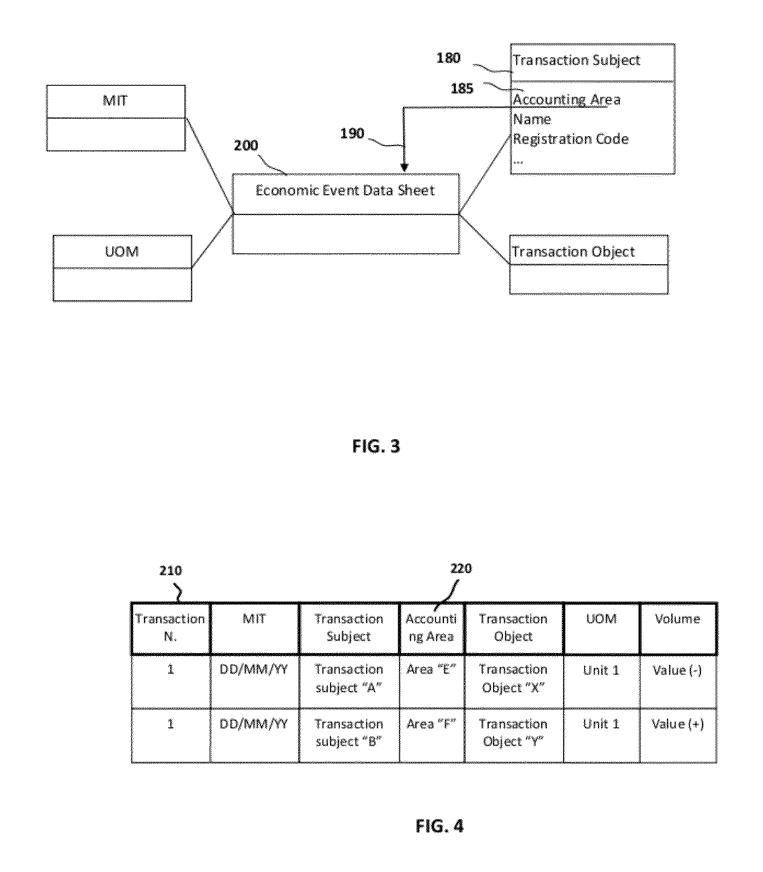

The third significant development of MDA is a method for producing the accounting balance sheet. For obtaining the balance sheet in the multidimensional data model, it is needed to single out one characteristic, whereas a subdivision based on this characteristic should form two parts of the balance equation. According to the present invention, such characteristic is chosen to be an attribute of Transaction Subject dimension table, named an “Accounting Area” and assuming one of two possible values. One of the values is assigned to a single subject or multiple subjects of transaction (in case of accounting in aggregated structures) and separates this subject (subjects) from calculations with agents, owners, and financial results. The two possible values of this characteristic form a dichotomic dividing of the business transactions and allow for producing a balance sheet. To provide such characteristic, EEDS is extended by the “Accounting Area” attribute. FIG. 3 shows the structure of extension (190) of the data sheet (200) by the “Accounting Area” attribute (185) of the dimensional table “Transaction Subject” (180. The result of the extension of EEDS (210) is shown in FIG. 4.

The balance sheet is formed on the basis of the dichotomy of the accounting area: the Internal Area objects form the balance sheet assets, the External Area objects form the liabilities and owner's equity. Separate pivot tables are created to reflect the balance sheet assets and liabilities. An example of the balance sheet, produced with the OLAP tools, is shown in FIG. 6. The basis of obtaining the balance sheet is EEDS with extensions (FIG. 5). In this example, the accounting is performed on behalf of Company 0 (350). For this company, a value of Internal Area (330) of the Accounting Area attribute is indicated. The rest of business transactions subjects receive a value of External Area (340) of the Accounting Area attribute.

The balance sheet form allows managing the depreciation separately (360).

The liabilities of the balance sheet are subdivided into two main parts depending upon a value of the “Relations” attribute. These are parts of “Ownership” (370) and “Counterpart” (380). This subdivision allows for separating the shareholder's equity of Company 0, marked as “Ownership” relations, from settlements with counterparts and with fiscal authorities.

A characteristic of the produced balance sheet is that the accounts receivable (385) are located in the liabilities of the balance sheet. Another characteristic of the balance sheet consists in that the assets part (and in the total) of the balance sheet contains positive numbers, whereas the liabilities part (and in the total) of the balance sheet contains negative numbers (other than accounts receivable). The accounts receivable (385) are placed in the liabilities part and have a positive value. Standard balance sheet forms are produced as a result of primitive transactions: by carrying forward the accounts receivable into the assets part and changing the sign of liabilities items.

The balance sheet total for assets is positive (390), the balance sheet total for the liabilities is negative (400). The total sum of the assets and liabilities is equal to zero. The results of assets and liabilities of Balance Sheet are equal in absolute numbers (modulus).

All the significant properties of business transactions are reflected in the attribute values. However, it is possible to add a field with a textual comment or textual description of the transaction to EEDS. Additional fields may be needed for connections of accounting with planning, business project management, etc.

MDA has a typical multidimensional data structure that can be implemented in a relational database in the form of relational tables. This multidimensional data structure can also be implemented with other types of databases that have necessary functionalities.

A user inputs a basic data volume into the data sheet. It is possible to use a special interface and other methods that simplify the input. Data for dimension tables are specified initially, or when registering a new property, not encountered previously.

The user gets data directly from the data sheet. The user can determine the report method either by prepared report templates or by an interface of the universal data processing OLAP. In the prepared report forms (report templates) special formatting elements can be employed, such as particular fonts, highlighting, different types of grid lines etc, as well as additional arithmetic operations upon the data. A disadvantage of the prepared report forms (report templates) is the necessity to update the forms and to check them out if there are changes in the dimension tables.

It should be however emphasized that the preferable main tool of MDA is the OLAP technology that provides for maximum freedom in data processing within the multidimensional data model.

The user can set up his/her own definitions for data input and can define extensions of the database structure.

MDA makes it possible to obtain a structure replicating the subdivision of data into traditional bookkeeping accounts. However, such replicating would generally make no sense, because the multidimensional structure can register not only all the analytical properties, implied in the bookkeeping accounts, but many other functionalities described above. In case of spreading the MDA practice, the bookkeeping accounts might become obsolete. The normative base and national accounting standards might be reviewed taking into consideration the characteristics of MDA.

### ADVANTAGES OF THE INVENTION

As shown above, the advantages of this invention are as follows:

1. According to characteristics of the OLAP processing, all accounting reports can be created dynamically upon a user's request.

2. As opposed to the traditional accountancy, the multidimensional data structure allows adding new structured information to each transaction record, enabling the accountant to create analytical tools that significantly exceed the analytical capacities of current reporting practice.

3. Intellectual analysis of data can be done within the limits of inputted information.

4. The use of positive and negative measurement values in different lines allows for visual control of the accuracy of records, as it is done in the accounting postings on debit of one account and on credit of another account.

5. The use of OLAP as a report generator ensures the accuracy of results and the equality of total amounts in the balance sheets. The bookkeeping accounts are derived dynamically from the multidimensional data structure.

6. Simplicity. The use of universal tools for creation of pivot tables, various filters and selections covers most of the needs in accounting data analysis without further programming by computer programmers.

What is claimed is:

1. At least one computer readable medium being a component of a programmable computer, said computer implements a data structure arranged on said readable medium, said data structure comprising:
an integrated economic event data sheet (EEDS) for registering changes of data occurred as a result of a business transaction, said business transaction has a subject, object, units of measure (UOM), and a value; said EEDS is represented by a table including the following economic event attributes:
MIT for recording a date and/or time of the business transaction, the MIT attribute is characterized with a MIT value;
Transaction Object for recording said object of the business transaction, the Transaction Object attribute is characterized with a Transaction Object value;
Transaction Subject for recording said subject of the business transaction, the Transaction Subject attribute is characterized with a Transaction Subject value;
UOM of the business transaction, the UOM attribute is characterized with a UOM value;
and
Value for recording said value of the business transaction, wherein the Value attribute assumes either a negative value or a positive value with equal modulus; and
a number of dimensional tables each associated with one of said economic event attributes; and
wherein:
said business transaction is recorded in two states within said EEDS for each said economic event attribute;
the two states are represented by a From state and a To state; and wherein:
said From state precedes the business transaction and completes as a result of the business transaction, while having a transaction numeric value always being negative;
said To state results from the business transaction while having a transaction numeric value always being positive, and
a total of the numeric values of said From state and said To state is equal to zero.

2. A method for producing an accounting balance sheet of a business entity; said accounting balance sheet is characterized by a balance equation, said business entity defines agents, owners, and financial results; said method comprising the steps of:
providing a computer readable medium being a component of a programmable computer; said computer implements calculations with said agents, said owners, and said financial results; said computer implements a data structure arranged on said readable medium, said data structure includes an integrated economic event data sheet (EEDS) for registering changes of data occurred as a result of a business transaction, said business transaction has an object, units of measure and a value; said EEDS is represented by a table including economic event attributes of:
MIT for recording a date and/or time of the business transaction, the MIT attribute is characterized with a MIT value;
Transaction Object for recording said object of the business transaction, the Transaction Object attribute is characterized with a Transaction Object value;
UOM for recording said units of measure of the business transaction, the UOM attribute is characterized with a UOM value; and
Value for recording said value of the business transaction, wherein the Value attribute assumes either a negative value or a positive value with equal modulus;
Transaction Subject for recording said subject of the business transaction, the Transaction Subject attribute is characterized with a Transaction Subject value; wherein said Transaction Subject attribute is represented by a Transaction Subject dimension table including an Accounting Area attribute assuming one of two possible values;
assigning one of the two possible values to a single subject or multiple subjects of said transaction, and
establishing a subdivision of the Accounting Area attribute, wherein said subdivision forms two parts of said balance equation.
